(19) United States
(12) Patent Application Publication
(10) Pub. No.: US 2013/0034635 A1
(43) Pub. Date: Feb. 7, 2013

(54) FRIED FOOD PRODUCT ON A STICK

(71) Applicant: Tomi J. Newberry, Panama City, FL (US)

(72) Inventor: Tomi J. Newberry, Panama City, FL (US)

(21) Appl. No.: 13/477,001

(22) Filed: May 21, 2012

(51) Int. Cl. A21D 8/00; A23P 1/08; A21D 13/00

(52) U.S. Cl. 426/134; 426/421

(57) ABSTRACT

A fried bread/dough/cake product is particularly well-suited for the amusement/theme park, carnival and festival industries. The fried food product may utilize a pre-cooked or raw dough product or a pre-cooked or raw cake batter that may be disposed on a stick and fried. The product may be pre-made and frozen (for raw dough/batter) or refrigerated or frozen (for pre-cooked dough or cake batter) and deep fried when needed. Various glazes and toppings can be provided to give consumers a unique, fresh dessert they can easily walk around and eat.

### BACKGROUND OF THE INVENTION

The present invention relates to food products and, more particularly, to a fried bread or cake products on a stick.

In the amusement/theme park, carnival and festival industries, consumers are not offered enough dessert products that they can easily eat while walking.

Currently, dessert products for these industries include funnel cakes. For vendors, this item is time consuming to produce, has excessive preparation time, wastes oil and is very messy to clean up. For consumers, the funnel cake is difficult and messy to eat.

As can be seen, there is a need for an improved fried bread product that can be easy to prepare for vendors and easy to carry and eat while walking for consumers.

### SUMMARY OF THE INVENTION

In one aspect of the present invention, a food product comprises one of a pre-cooked dough product, a pre-cooked cake product, a raw dough product and a raw cake batter that is deep fried; and a stick inserted into the food product to provide a handle for consumption of the food product.

In another aspect of the present invention, a method for preparing a fried food product comprises obtaining at least one of a frozen dough product, a frozen cake batter product, a pre-cooked bread product and a pre-cooked cake product pre-shaped as an elongated food product; inserting a stick into the elongated food product; and deep frying the elongated food product.

In still another aspect of the present invention, a method for providing a portable dessert product comprises deep frying a pre-shaped elongated food product, the elongated food product selected from the group consisting of a frozen dough product, a frozen cake batter product, a pre-cooked bread product and a pre-cooked cake product pre-shaped as an elongated food product; and inserting a stick into the elongated food product.

These and other features, aspects and advantages of the present invention will become better understood with reference to the following drawings, description and claims.

### BRIEF DESCRIPTION OF THE DRAWINGS

FIG. 1 is a perspective view of a fried bread product according to an exemplary embodiment of the present invention; and

FIG. 2 is a flow chart describing an exemplary process for making a fried bread product according to an exemplary embodiment of the present invention.

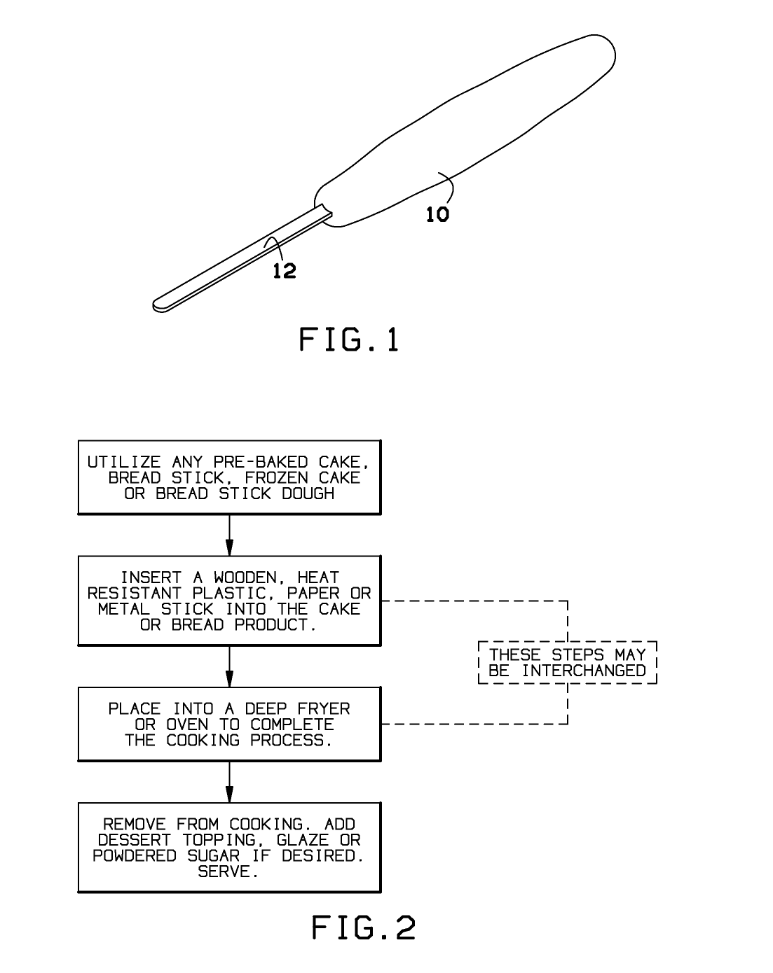

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a fried bread/dough/cake product that may be particularly well-suited for the amusement/theme park, carnival and festival industries. The fried food product may utilize a pre-cooked or raw dough product or a pre-cooked or raw cake batter that may be disposed on a stick and fried. The product may be pre-made and frozen (for raw dough/batter) or refrigerated or frozen (for pre-cooked dough or cake batter) and deep fried when needed. Various glazes and toppings can be provided to give consumers a unique, fresh dessert they can easily walk around and eat.

Referring now to the Figures, a fried bread/dough/batter product 10 (also referred to as a fried food product 10) may be disposed on a stick 12. The food product 10 may be prepared from any pre-cooked or raw dough product on a stick or from any pre-cooked or raw cake batter on a stick to be fried. Typically, when the dough or cake batter is raw, the product may be frozen, with the stick inserted. Typically, when the dough or cake batter is pre-cooked, the product may be either frozen or refrigerated, with the stick inserted.

In some embodiments of the present invention, the food product 10 may be supplied with the stick 12 pre-inserted. In other embodiments, the vendor may insert the stick 12 prior to frying the food product 10. In still other embodiments, the food product 10 may be fried first, and the stick may be inserted after frying.

The stick 12 may be made of various materials. The stick 12 should be heat resistant, especially if inserted prior to frying. In exemplary embodiments, the stick 12 may be made from wood, heat resistant plastic, paper or metal.

The food product 10 may be pre-shaped prior to deep frying. The food product 10 may be an elongated product having a length from about 4 inches to about 12 inches, for example, and a diameter from about 1 inch to about 3 inches. The sizes described above, however, are exemplary and other sizes may be contemplated within the scope of the present invention. However, typically, an elongated food product may be well-suited for presentation on a stick for convenient handling and consumption.

The food product 10 may be deep fried at various temperatures. For example, the food product 10 may be deep fried at 350-375 degrees until the product is golden brown.

Unlike funnel cakes, which may be messy to prepare and difficult to eat while walking around, the fried food product of the present invention may be well suited for serving at functions where people are generally mobile, as the product of the present invention is portable and easily carried.

In some embodiments, the fried food product 10 may be topped with various toppings, such as dessert toppings, glaze, powdered sugar, nuts, or the like. In some embodiments, a vendor may have a selection of toppings and the consumer can watch as the vendor prepares their freshly prepared dessert to their liking. In some embodiments, the product may be served and carried in a typical paper hot dog container, where the container may be easy to carry and may catch any toppings that may fall from the dessert.

The food product of the present invention can provide attendees of festivals, carnivals, amusement parks, and the like, the perfect portable dessert on a stick. The deep fried bread or cake product is ideal as a walk-around dessert.

It should be understood, of course, that the foregoing relates to exemplary embodiments of the invention and that modifications may be made without departing from the spirit and scope of the invention as set forth in the following claims.

What is claimed is:

1. A food product comprising:
one of a pre-cooked dough product, a pre-cooked cake product, a raw dough product and a raw cake batter that is deep fried; and
a stick inserted into the food product to provide a handle for consumption of the food product.

2. The food product of claim 1, wherein the raw cake batter and raw dough product is pre-shaped and frozen.

3. The food product of claim 1, wherein the stick is present in the food product during deep frying.

4. A method for preparing a fried food product, the method comprising:
obtaining at least one of a frozen dough product, a frozen cake batter product, a pre-cooked bread product and a pre-cooked cake product pre-shaped as an elongated food product;
inserting a stick into the elongated food product; and
deep frying the elongated food product.

5. The method of claim 4, wherein the elongated food product is deep fried prior to insertion of the stick.

6. The method of claim 4, further comprising adding a topping to the deep fried elongated food product.

7. A method for providing a portable dessert product, the method comprising:
deep frying a pre-shaped elongated food product, the elongated food product selected from the group consisting of a frozen dough product, a frozen cake batter product, a pre-cooked bread product and a pre-cooked cake product pre-shaped as an elongated food product; and
inserting a stick into the elongated food product.

8. The method of claim 7, wherein the elongated food product is deep fried prior to insertion of the stick.

9. The method of claim 7, wherein the stick is inserted in the elongated food product prior to deep frying.

10. The method of claim 7, further comprising adding a topping to the deep fried elongated food product.
